(19) United States
(12) Patent Application Publication
(10) Pub. No.: US 2026/0351212 A1
(43) Pub. Date: Nov. 5, 2026

(54) DISPLAY DEVICE

(71) Applicant: LG Display Co., Ltd., Seoul (KR)

(72) Inventors: Chang Mo YANG, Paju-si (KR); Woong Jin SEO, Paju-si (KR); Jung Geun JO, Paju-si (KR)

(73) Assignee: LG Display Co., Ltd., Seoul (KR)

(21) Appl. No.: 19/658,456

(22) Filed: Apr. 24, 2026

(30) Foreign Application Priority Data
Apr. 29, 2025 (KR) 10-2025-0056535

(51) Int. Cl. G09G 3/36; G09G 3/3225

(52) U.S. Cl. CPC G09G 3/3607; G09G 3/3225; G09G 2310/08; G09G 2320/0238; G09G 2320/0242; G09G 2320/0276; G09G 2360/148; G09G 2360/16

(57) ABSTRACT

A display device includes a display panel that includes a first display region including a plurality of first pixels and a second display region including a plurality of second pixels and a plurality of monopixels, and a sensor configured to receive light through the second display region, wherein the second display region operates in a sensing mode in which light is incident on the sensor when the sensor operates and in a display mode in which an image is displayed, and in the display mode, the plurality of monopixels have different gray levels.

### CROSS-REFERENCE TO RELATED APPLICATION

This application claims priority to and the benefit of Korean Patent Application No. 10-2025-0056535, filed on Apr. 29, 2025, the disclosure of which is incorporated herein by reference in its entirety.

### BACKGROUND

### Field of the Specification

The present specification relates to a display device, and more particularly, to a display device capable of implementing a full-screen display with improved expressiveness of an imaging region in display mode.

### Discussion of Related Art

As the information society develops, the demand for display devices for displaying images is increasing in various forms, and recently, various display devices such as liquid crystal display devices (liquid crystal displays (LCDs)), plasma display devices (plasma display panels (PDPs)), and organic light-emitting display devices (organic light-emitting diodes (OLEDs)) have been utilized.

Recently, multimedia functions of electronic devices such as mobile terminals have been improving. For example, cameras are being built in mobile terminals as a basic component, and the resolution of the cameras is increasing to the level of conventional digital cameras. However, a front camera of a mobile terminal limits screen design, making screen design difficult. Although screen designs including a notch or a punch hole have been adopted for mobile devices to reduce the space occupied by the camera, the screen size is still limited by the camera, making it difficult to implement a full-screen display.

To implement a full screen display, a method of providing an imaging region in which pixels are disposed in the screen of a display panel and arranging a camera and/or various sensors in the imaging region is proposed. The camera and/or various sensors may be disposed under the display panel, and the imaging region disposed in the screen may include color pixels for displaying the screen and a transmitting portion for transmitting external light to introduce external light into the camera and/or various sensors. The imaging region has a problem in that the density of pixels per unit area is lower than that of the periphery of the imaging region, resulting in reduced resolution and thus degraded expressiveness of the image.

### SUMMARY

The present specification is directed to, for example, providing a display device capable of implementing a full-screen display with improved expressiveness of an imaging region in display mode.

The present specification is also directed to, for example, providing a display device with improved invisibility of a boundary region of an imaging region (a second display region) in display mode.

The objects to be achieved in the present specification are not limited to those described above, and other objects that are not described will be clearly understood from the description below by those skilled in the art to which the technical idea of the present specification pertains.

According to an aspect of the present specification, a display device according to one or more example embodiments of the present specification includes a display panel including a first display region including a plurality of first pixels, and a second display region including a plurality of second pixels and a plurality of monopixels, and a sensor configured to receive light through the second display region, wherein the second display region operates in a sensing mode in which light is incident on the sensor when the sensor operates and in a display mode in which an image is displayed, and in the display mode, the plurality of monopixels have different gray levels.

It is to be understood that both the foregoing general description and the following detailed description of the present specification are by way of example and are not intended to limit the disclosures as claimed.

### BRIEF DESCRIPTION OF THE DRAWINGS

The accompanying drawings, which are included to provide a further understanding of the present specification and are incorporated in and constitute a part of this application, illustrate example embodiments of the present specification and together with the description serve to explain various principles of the present specification. In the drawings:

FIG. 1 is a conceptual diagram of a display device according to an example embodiment of the present specification;

FIG. 2 is an exploded perspective view of the display device according to an example embodiment of the present specification;

FIG. 3 is a cross-sectional view of the display device according to an example embodiment of the present specification;

FIG. 4 is a view showing a first display region and a second display region according to an example embodiment of the present specification;

FIG. 5 is a view showing a first pixel group and a second pixel group according to an example embodiment of the present specification;

FIG. 6 is a view showing a layout diagram of a color filter according to an example embodiment of the present specification;

FIG. 7 is a block diagram for describing a process of calculating data of a system unit or a timing controller according to an example embodiment of the present specification;

FIG. 8 shows an algorithm for calculating a correction value of the system unit or the timing controller according to an example embodiment of the present specification;

FIG. 9 is a view showing the gray levels input to a second pixel group according to an example embodiment of the present specification;

FIG. 10 is a view showing the correction values calculated for the second pixel group according to an example embodiment of the present specification;

FIG. 11 shows an example algorithm for section S100 in FIG. 8;

FIG. 12 is a view showing an example of gray levels input to a second pixel group;

FIG. 13 is a view showing an example of the correction values calculated for the second pixel group of FIG. 12;

FIG. 14 is a view showing another example of gray levels input to the second pixel group;

FIG. 15 is a view showing another example of the correction values calculated for the second pixel group of FIG. 14;

FIG. 16 is a view showing a first display region and a second display region according to another example embodiment of the present specification;

FIG. 17 is a view showing an eleventh display region and a twelfth display region according to another example embodiment of the present specification;

FIG. 18 is a view showing an eleventh pixel group according to another example embodiment of the present specification;

FIG. 19 is a view for describing a method of compensating the luminance of a boundary region according to another example embodiment of the present specification; and

FIG. 20 shows an image showing the screen before and after the compensation algorithm according to an example embodiment of the present specification is applied.

### DETAILED DESCRIPTION

Advantages and features of the present specification and methods of achieving them will become apparent with reference to the following example embodiments, which are described in detail, in conjunction with the accompanying drawings. The present specification, however, is not limited thereto to the example embodiments disclosed hereinafter, but can be practiced in many different forms. These example embodiments are provided merely to make the disclosure of the present specification more complete and to make the scope of the specification more apparent to one of ordinary skill in the art to which the present specification belongs. The protected scope of the present specification may be defined by the claims and their equivalents.

The shapes, sizes, proportions, angles, numbers, etc., disclosed in the drawings to illustrate example embodiments of the present specification are by way of example, and example embodiments of the present specification are not limited thereto. In addition, in describing the present specification, detailed descriptions of relevant known technology may be omitted where such detailed descriptions may unnecessarily obscure features or aspects of the present specification.

Where such terms as ‘including,’ ‘having,’ ‘consisting of,’ and the like are used in the present specification, other parts may be added unless a more specific term like ‘only’ is used. A case in which a component is expressed in a singular form includes a plural form, and vice versa, unless explicitly stated otherwise.

In interpreting a component, the component is to be interpreted as including the margin of error even when there is no separate explicit description.

Where a positional relationship is described, for example, where the positional relationship of two parts is described with such terms as “on,” “above,” “under,” or “beside,” one or more other parts may be located between the two parts unless a more specific term like “right” or “directly” is used.

A case where an element or a layer is described as being on another element or layer includes both cases in which the element/layer is directly on the other element/layer and cases in which still another element/layer is interposed between the other element/layer and the element/layer.

Although such terms as “first,” “second,” and the like may be used to describe various components, these components are not limited by these terms. These terms are only used to refer to one component separately from another. Accordingly, a first component mentioned below may also be a second component, and vice versa, within the technical spirit of the present disclosure.

Throughout the specification, the same reference numerals refer to the same components unless otherwise specified.

The size and thickness of each component shown in the drawings are shown for convenience of description and do not necessarily limit sizes and thicknesses of the components described in the present specification.

Features of various embodiments of the present specification may be partially or entirely combined with each other, and technically, various linkages and operations are possible, and the embodiments may be implemented independently of each other or together in association with each other.

In the present specification, a “device” may include a display device, such as a liquid crystal module (LCM) or an organic light-emitting display device (OLED Module), including a display panel and a drive unit for driving the display panel. It may also include a set electronic apparatus or set device, such as a laptop computer, a television, a computer monitor, an automotive apparatus or other form of vehicle, which is a complete product or final product including LCMs, OLED modules, and the like, and a mobile electronic apparatus, such as a smartphone or an electronic pad, and the like.

A display device in the present specification may therefore include a display device itself, such as an LCM, OLED module, and the like, and a set device, which is an application or end-consumer device that includes an LCM, OLED module, and the like.

And, in some example embodiments, an LCM, OLED module comprising a display panel and a driving part, and the like, may be expressed as a “display device,” and an electronic device as a finished product including the LCM, OLED module may be distinguished and expressed as a “set device.” For example, a display device may include a liquid crystal (LCD) or organic light emitting (OLED) display panel, and a source PCB that is a control portion for driving the display panel. The set device may further comprise a set PCB, which is a set control unit electrically connected to the source PCB to drive the entire set device.

The display panel used in example embodiments of the present specification may include any form of a display panel, such as a liquid crystal display panel, an organic light-emitting diode (OLED) display panel, and an electroluminescent display panel. However, the present specification is not limited thereto.

Hereinafter, various example embodiments of the present specification will be described in detail with reference to the accompanying drawings.

The components shown in the drawings are not necessarily drawn to scale for convenience of illustration and are not limited thereto.

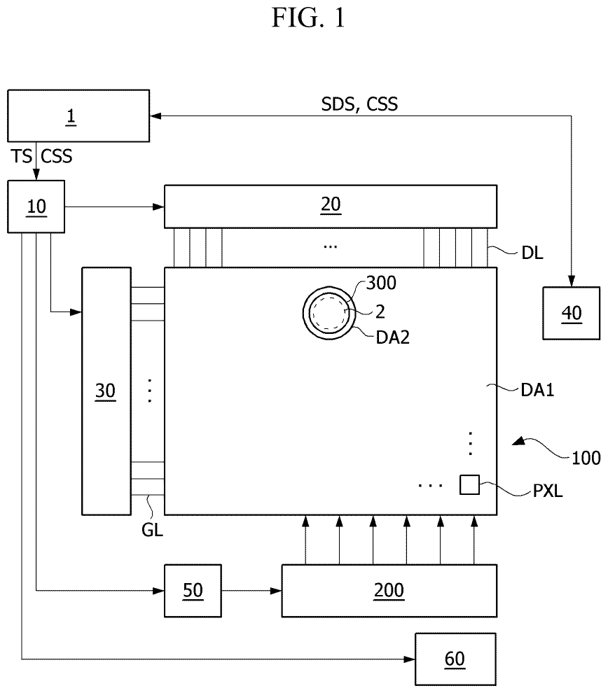

FIG. 1 is a conceptual diagram of a display device 1000 according to an example embodiment of the present specification.

As shown in FIG. 1, the display device 1000 according to an example embodiment may include a display panel 100 including a first display region DA1 and a second display region DA2 that display an image according to input image data, light source modules 200 and 300 that supply light to the display panel 100, and a sensor 2 that receives light. The display device 1000 may include a plurality of driving units and control units that control the display panel 100, the light source modules 200 and 300, and the sensor 2.

The display panel 100 may have a plurality of gate lines GL and a plurality of data lines DL that intersect to define pixels PXL, and each of the pixels PXL may include a thin film transistor and a storage capacitor. The thin film transistor is switched by a scan signal supplied through the gate line GL, and when the thin film transistor is turned on, image data (data voltage) supplied through the data line DL may be supplied to the pixel PXL.

The display panel 100 may include a pixel electrode 111 that applies a data voltage to the pixel PXL and a common electrode 121 that applies a common voltage. The pixel electrode 111 may be disposed on a lower board 110, and the common electrode 121 may be disposed on the lower board 110 or an upper board 120.

The display panel 100 may be a liquid crystal panel including a liquid crystal layer. The display panel 100 may implement an image by controlling the transmittance of light supplied from the light source module by changing the arrangement of liquid crystals by an electric field between a data voltage and a common voltage and controlling the arrangement of liquid crystals. However, embodiments of the present specification are not limited thereto. For example, the display panel 100 may be a display panel that includes organic light-emitting elements or inorganic light-emitting elements.

The display panel 100 may include the first display region DA1 and the second display region DA2 for displaying an image. The second display region DA2 may be defined as a region of which a lower portion has the sensor 2 disposed thereon. For example, the second display region DA2 may be defined as a region in which the sensor 2 disposed under the display panel 100 receives light. The second display region DA2 may have any of various shapes, such as a circle, an ellipse, and a polygon. The size of the second display region DA2 may be smaller than that of the first display region DA1, but embodiments of the present specification are not limited thereto.

The first display region DA1 and the second display region DA2 may each have pixels PXL and implement a full-screen display. According to the example embodiment, the first display region DA1 may operate only in a normal mode for displaying an image, while the second display region DA2 may operate in a display mode for displaying an image and a sensing mode for receiving external light.

The light source modules 200 and 300 may include a first light source module 200 that supplies light to the first display region DA1 and a second light source module 300 that supplies light to the second display region DA2.

The first light source module 200 may be controlled by a first light source driving unit 50, and the second light source module 300 may be controlled by a second light source driving unit 60. The first light source module 200 and the second light source module 300 may be simultaneously turned on or off or may be turned on or off at different timings.

The first light source module 200 may be turned on in both display mode and sensing mode. The second light source module 300 may be turned on during a display mode period and turned off during a sensing mode period. Since the second light source module 300 is turned off during the sensing mode period so that light entering from the outside and light emitted from the second light source module 300 are not mixed, noise may be minimized or reduced.

At least one sensor 2 may be disposed in the second display region DA2. The sensor 2 may receive light incident on the second display region DA2. The sensor 2 may include various sensors that receive light, such as a red-green-blue (RGB) camera, an illuminance sensor, or an infrared camera.

The sensor control unit 40 may utilize light incident to the sensor 2 to generate an image or generate a three-dimensional (3D) feature map. For example, the sensor 2 may include an RGB camera or an infrared camera. For example, the sensor 2 may include an RGB camera and an infrared camera, but embodiments of the present specification are not limited thereto.

A system unit 1 may supply signals for driving, such as image data and a timing signal TS, to a timing controller 10. The timing signal TS may include a clock signal, a horizontal and vertical synchronization signal, a gate and data enable signal, etc.

The system unit 1 may receive a sensor driving signal SDS from the sensor control unit 40. The system unit 1 may transmit an imaging synchronization signal CSS and a control signal to a data driving unit 20, the sensor control unit 40, and the second light source driving unit 60 to generate an image according to the sensor driving signal SDS. Therefore, the data driving unit 20, the sensor control unit 40, and the second light source driving unit 60 may be synchronized and operate in camera mode. However, embodiments of the present specification are not limited thereto. The timing controller 10 may receive a control signal from the system unit 1 and transmit the control signal and the imaging synchronization signal CSS to the data driving unit 20, the second light source driving unit 60, and the sensor control unit 40.

The timing controller 10 may generate a gate control signal for controlling the gate driving unit 30 and a data control signal for controlling the data driving unit 20 using the timing signal TS received from the system unit 1.

The timing controller 10 may convert the image signal received from the system unit 1 into digital image data (R, G, and B) in frame units and supply the converted digital image data to the data driving unit 20. The gate control signal may be supplied to the gate driving unit 30, and the data control signal may be supplied to the data driving unit 20.

The gate driving unit 30 may generate a scan signal for driving a thin film transistor formed in each of the pixels PXL of the display panel 100 based on the gate control signal supplied from the timing controller 10. The generated scan signals may be sequentially supplied to the plurality of gate lines GL.

The data driving unit 20 may sequentially receive digital image data (R, G, and B) supplied from the timing controller 10, convert the received digital image data into a data voltage by referring to a reference voltage, and supply the converted digital image data to each pixel of the display panel 100.

The system unit 1 may supply a light source control signal to the first light source driving unit 50 and the second light source driving unit 60. The first light source driving unit 50 and the second light source driving unit 60 may supply a light source driving signal according to the light source control signal to light sources of the first light source module 200 and the second light source module 300. The light sources of the first light source module 200 and the second light source module 300 may each be turned on according to the light source driving signal to generate light.

The light source may be a light-emitting diode (LED), an external electrode fluorescent lamp (EEFL), a cold cathode fluorescent lamp (CCFL), a laser diode, or the like, but embodiments of the present specification are not limited thereto.

The light source control signal may include an LED enable signal, a pulse width signal (pulse width modulation (PWM)), etc. The LED enable signal may serve to control the timing of turn-on and turn-off of the light source. For example, when the LED enable signal applied to the first light source driving unit 50 and the second light source driving unit 60 is at a high level, the light source may be turned on. When the LED enable signal applied to the first light source driving unit 50 and the second light source driving unit 60 is at a low level, the light source may be turned off. The first light source driving unit 50 and the second light source driving unit 60 may be LED drivers, but embodiments of the present specification are not limited thereto.

The sensor control unit 40 may process the light received from the sensor 2 to generate an image or a three-dimensional (3D) feature map. The sensor control unit 40 may receive a sensor driving signal SDS input from the outside and transmit the sensor driving signal SDS to the system unit 1.

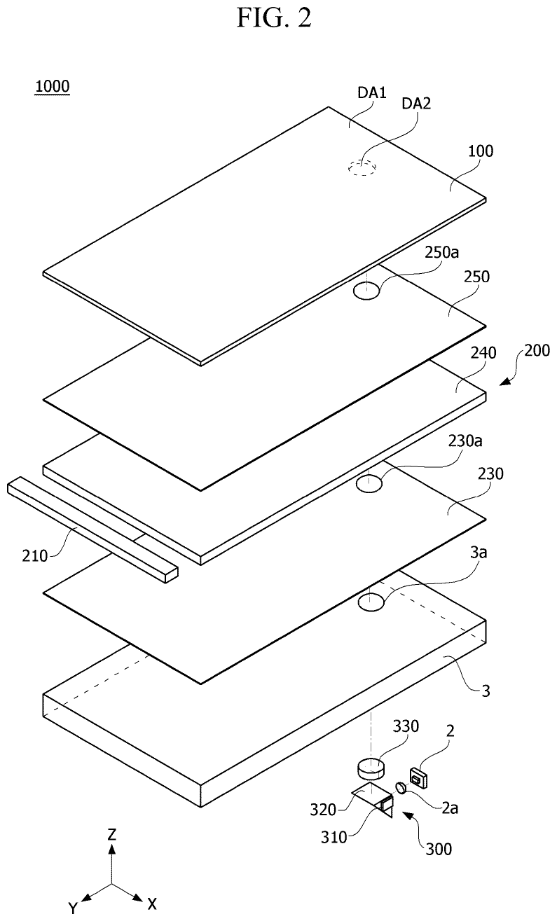

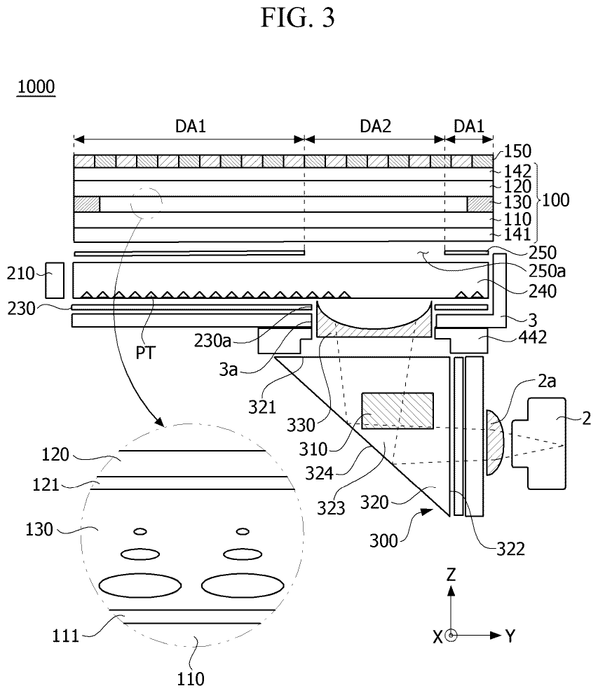

FIG. 2 is an exploded perspective view of the display device 1000 according to an example embodiment of the present specification. FIG. 3 is a cross-sectional view of the display device 1000 according to an example embodiment of the present specification.

As shown in FIGS. 2 and 3, the display device 1000 may include a case 3, the first light source module 200 disposed in the case 3, the display panel 100 disposed on the first light source module 200, and the second light source module 300 disposed under the first light source module 200.

The first light source module 200 may include a light guide member 240 disposed in the case 3, a plurality of first light sources 210 disposed on one side of the light guide member 240, a reflector 230 disposed under the light guide member 240, and a plurality of optical sheets 250 disposed on the light guide member 240. At least a portion of the first light source module 200 may be disposed on a bottom surface of the case 3.

The light guide member 240 may convert light emitted from the plurality of light sources into a surface light source. The light guide member 240 may be defined as a light guide plate or a light guide member. Light emitted from the plurality of first light sources 210 may be incident on one side of the light guide member 240 and proceed to the other side. Light may be reflected from the inside of the light guide member 240 and emitted toward the display panel 100. Therefore, uniform light may be emitted through an upper surface of the light guide member 240.

According to the example embodiment, the light guide member 240 may include a plurality of patterns PT disposed in a region corresponding to the first display region DA1. Light of the first light sources 210 may be emitted from the light guide member 240 by the plurality of patterns PT. However, the plurality of patterns PT may not be disposed in a region of the light guide member 240 corresponding to the second display region DA2. Accordingly, although the first light source module 200 may be disposed to overlap the first display region DA1 and the second display region DA2, light may be totally reflected in a portion corresponding to the second display region DA2. Therefore, the first light source module 200 may not supply light to the second display region DA2.

The plurality of optical sheets 250 may form a uniform surface light source by concentrating or diffusing light emitted from the light guide member 240. The plurality of optical sheets 250 may include a prism sheet and/or a diffusion sheet.

First openings 250a may each be formed in portions of the plurality of optical sheets 250 corresponding to the second display region DA2. A second opening 230a may be formed in a portion of the reflector 230 corresponding to the second display region DA2. Therefore, external light incident on the second display region DA2 may pass through the first opening 250a and the second opening 230a and may be incident on the second light source module 300.

The second light source module 300 may include a path changing member 320 onto which external light is incident and at least one second light source 310 that supplies light to the path changing member 320. The path changing member 320 may have a triangular cross-section but is not limited thereto. For example, the path changing member 320 may have a polygonal cross-section.

The path changing member 320 may include a reflective surface 324 that reflects external light incident on a first side surface 321 facing the second display region DA2 or the light guide member 240 so that the external light is incident on the sensor 2. The path changing member 320 may be disposed to overlap the light guide member 240 in the second display region DA2.

The sensor 2 may be disposed on a second side surface 322 and may receive the external light reflected by the reflective surface 324. A first lens 330 that concentrates incident light may be disposed above the path changing member 320. The first lens 330 may be fixed to the case 3 by a bracket 442. A second lens 2a may be disposed between the path changing member 320 and the sensor 2. The second lens 2a may concentrate the light passing through the first lens 330 and reflected by the path changing member 320 onto the sensor 2.

The second light source 310 may be disposed on a third side surface 323 of the path changing member 320. The path changing member 320 may direct light from the second light source 310 to the first side surface 321. The path changing member 320 may include various reflective structures for directing light supplied from the second light source 310 to the first side surface 321. For example, reflective coating layers may be formed on the remaining side surfaces among the plurality of side surfaces of the path changing member 320 so that light passes through only the first side surface 321, the second side surface 322, and the third side surface 323.

The third side surface 323 of the path changing member 320 may be disposed so as not to face the second side surface 322 and the reflective surface 324. Therefore, since the second light source 310 does not block the path of incident external light, the sensor 2 may receive sufficient light.

The display panel 100 may include a first board 110, a second board 120, and a liquid crystal layer 130 disposed between the first board 110 and the second board 120. A first polarizing plate 141 may be disposed under the first board 110, and a second polarizing plate 142 may be disposed on the second board 120. A color filter 150 may be disposed above the second board 120.

The optical axes of the first polarizing plate 141 and the second polarizing plate 142 may be orthogonal to each other. Light passing through the first polarizing plate 141 may have its optical axis changed by the liquid crystal layer 130 and pass through the second polarizing plate 142. Since an electric field is formed when a voltage is applied to the pixel electrode 111 disposed on the first board 110 and the common electrode 121 disposed on the second board 120, the liquid crystal of the liquid crystal layer 130 may rotate. The transmittance of light passing through the display panel 100 may be adjusted according to the degree to which the liquid crystal of the liquid crystal layer 130 rotates. The configuration of the polarizing plate and the display panel 100 may be applied without limitation to the configuration of a known liquid crystal display panel.

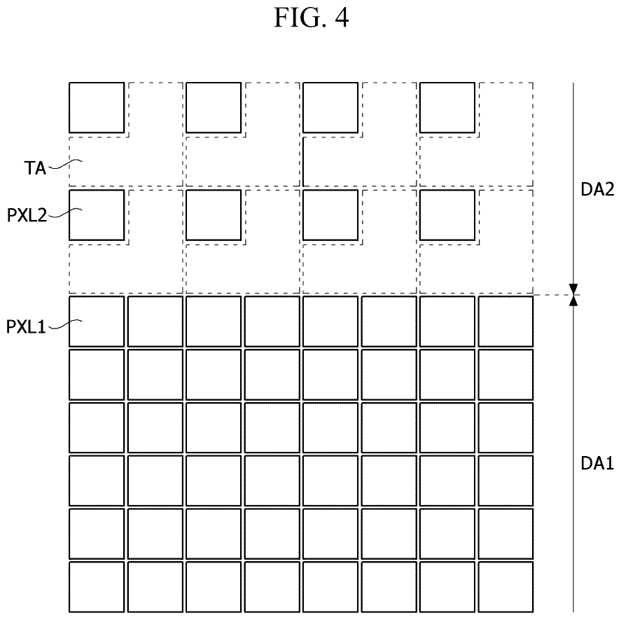

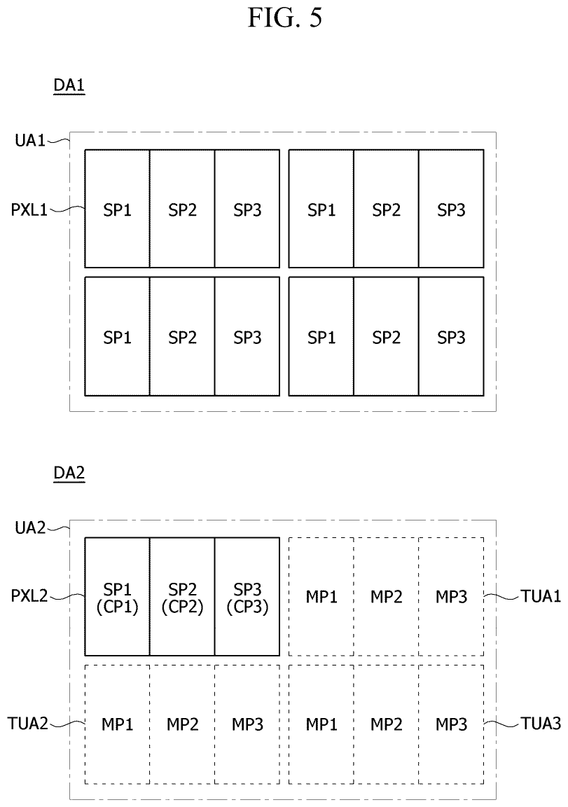

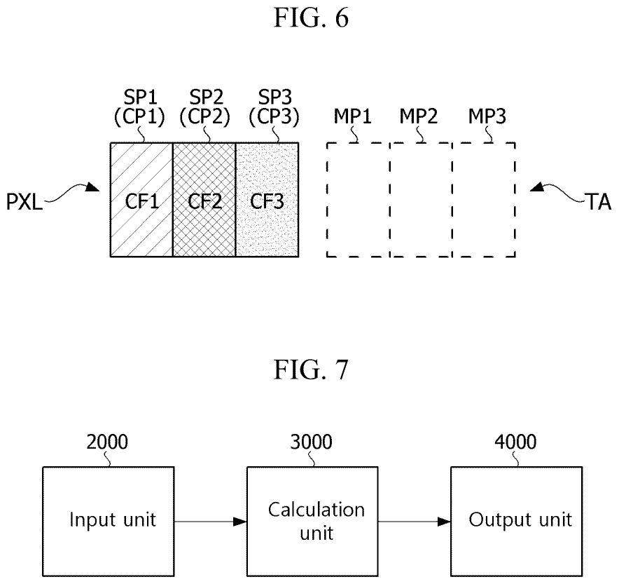

FIG. 4 is a view showing the first display region and the second display region according to an example embodiment of the present specification. FIG. 5 is a view showing a first pixel group and a second pixel group according to an example embodiment of the present specification. FIG. 6 is a view showing a layout diagram of a color filter according to an example embodiment of the present specification.

As shown in FIGS. 4 to 6, a display device according to an example embodiment of the present specification may include a display panel including a first display region DA1 including a plurality of first pixels PXL1, and a second display region DA2 including a plurality of second pixels PXL2 and a plurality of monopixels TUA1, TUA2, and TUA3, and a sensor that receives light through the second display region DA2, wherein the second display region DA2 operates in a sensing mode in which light is incident on the sensor when the sensor operates and in a display mode in which an image is displayed, and in the display mode, the plurality of monopixels TUA1, TUA2, and TUA3 may have different gray levels.

As shown in FIGS. 4 to 6, the first display region DA1 and the second display region DA2 may include pixel groups including different configurations. The first display region DA1 may include a plurality of first pixel groups UA1, and the second display region DA2 may include a plurality of second pixel groups UA2. The first pixel groups UA1 may each include at least one first pixel PXL1, and the second pixel groups UA2 may each include at least one second pixel PXL2 and at least one monopixel TUA (TUA1, TUA2, and TUA3).

The areas of the first pixel group UA1 and the second pixel group UA2 may be substantially the same. The first pixel group UA1 may be any region defined as a control group of the second pixel group UA2 to describe the second pixel group UA2. Therefore, the first pixel group UA1 may be determined based on the second pixel group UA2. The area or configuration of the first pixel group UA1 may change as the area or configuration of the second pixel group UA2 changes.

The second pixel group UA2 may be the smallest unit of the second pixel PXL2 and the monopixel TUA that are regularly disposed in the second display region DA2. The second pixel group UA2 may include a single second pixel and a plurality of monopixels. According to an example embodiment, the second pixel group UA2 may include a second pixel PXL2, a first monopixel TUA1, a second monopixel TUA2, and a third monopixel TUA3. However, the display device of the present specification is not limited thereto, and the number of second pixels and monopixels included in the second pixel group UA2 may vary.

Hereinafter, in the implemented example embodiments according to FIGS. 4 to 14, an example in which the second pixel group UA2 includes the second pixel PXL2, the first monopixel TUA1, the second monopixel TUA2, and the third monopixel TUA3 is described.

According to an example embodiment, the first pixel group UA1 may include four first pixels PXL1 in an area or configuration corresponding to the second pixel group UA2. However, the display device of the present specification is not limited thereto, and the number of first pixels included in the first pixel group UA1 may vary as the number of second pixels and monopixels included in the second pixel group UA2 varies.

The number of first pixels PXL1 per unit area in the first display region DA1 may be greater than the number of second pixels PXL2 per unit area in the second display region DA2. Additionally, the number of first pixels PXL1 per unit area in the first display region DA1 may be the same as the total number of second pixels PXL2 and monopixels TUA1, TUA2, and TUA3 per unit area in the second display region DA2.

Each of the first pixels PXL1 may include a plurality of sub-pixels. Each of the first pixels PXL1 may include a first subpixel SP1, a second subpixel SP2, and a third subpixel SP3, but the present specification is not limited thereto.

Each of the second pixels PXL2 may include a plurality of subpixels. Each of the second pixels PXL2 may include a first subpixel SP1, a second subpixel SP2, and a third subpixel SP3, but the present specification is not limited thereto.

The first to third subpixels SP1, SP2, and SP3 included in the first pixel PXL1 and the first to third subpixels SP1, SP2, and SP3 included in the second pixel PXL2 may have the same color arrangement structure, but the present specification is not limited thereto.

The first to third subpixels SP1, SP2, and SP3 may emit different colors. For example, the first subpixel SP1 may be a red subpixel (R), the second subpixel SP2 may be a green subpixel (G), and the third subpixel SP3 may be a blue subpixel (B), but the present specification is not limited thereto.

Color filters CF1, CF2, and CF3 of different colors may be disposed on the first and second pixels PXL1 and PXL2. A first color filter CF1 may be disposed on the first subpixel SP1, a second color filter CF2 may be disposed on the second subpixel SP2, and a third color filter CF3 may be disposed on the third subpixel SP3. For example, the first color filter CF1 may be a red color filter, the second color filter CF2 may be a green color filter, and the third color filter CF3 may be a blue color filter, but the present specification is not limited thereto.

In the present specification, in order to distinguish between the subpixels disposed in the first display region DA1 and the subpixels disposed in the second display region DA2, the first to third subpixels SP1, SP2, and SP3 disposed in the second display region DA2 may be referred to as the first to third color pixels CP1, CP2, and CP3.

A plurality of monopixels TUA1, TUA2, and TUA3 may be disposed in a transmitting portion TA of the second display region DA2. The transmitting portion TA may be a region in which the color filter is not disposed. That is, the plurality of monopixels TUA1, TUA2, and TUA3 are regions in which the transmittance of light is adjusted and may have only luminance. The plurality of monopixels TUA1, TUA2, and TUA3 may have a function of receiving external light by maximizing or increasing the transmittance in a sensing mode in which light is incident on the sensor when the sensor operates. The plurality of monopixels TUA1, TUA2, and TUA3 may output a gray level(or gradation value) at its maximum value during the sensing mode period. The plurality of monopixels TUA1, TUA2, and TUA3 may have a function of adjusting the transmittance in a display mode in which an image is displayed and compensating the luminance of the second pixel PXL2 disposed in the second display region DA2 and/or a corresponding second pixel group UA2.

The transmitting portion TA is shown as being divided into a plurality of regularly repeating regions in the drawing, but the transmitting portion TA may be a single region in which a plurality of monopixels are disposed by excluding the second pixel PXL2 from the second display region DA2.

Each monopixel TUA1, TUA2, and TUA3 may be structurally identical to each first or second pixel PXL1 or PXL2, except that the color filter is not disposed. For example, the plurality of monopixels TUA1, TUA2, and TUA3 may each have a pixel electrode disposed therein so that the light transmittance of the plurality of monopixels TUA1, TUA2, and TUA3 is controlled by the respective pixel electrodes.

Each of the monopixels TUA1, TUA2, and TUA3 may include a plurality of sub-monopixels MP1, MP2, and MP3. Each of the monopixels TUA1, TUA2, and TUA3 may include first to third sub-monopixels MP1, MP2, and MP3 corresponding to the first to third color pixels CP1, CP2, and CP3 of the second pixel PXL2. A first sub-monopixel MP1 may correspond to a first color pixel CP1, a second sub-monopixel MP2 may correspond to a second color pixel CP2, and a third sub-monopixel MP3 may correspond to a third color pixel CP3. Here, a corresponding sub-monopixel and color pixel may refer to those disposed at the same location in a second pixel and each monopixel.

The plurality of sub-monopixels MP1, MP2, and MP3 disposed in the monopixels TUA1, TUA2, and TUA3 may be driven with the same gray level. The plurality of sub-monopixels MP1, MP2, and MP3 may be driven independently, but with the same gray level. This will be described in detail below with reference to other drawings.

The first to third monopixels TUA1, TUA2, and TUA3 may compensate the luminance of the second pixel PXL2 included in the same second pixel group UA2. In a compensation algorithm, each sub-monopixel(or monopixel) may be intended to compensate the luminance of the corresponding color pixel. Accordingly, the display device according to an example embodiment of the present specification may further improve the image expressiveness of the second display region DA2.

In some cases, even when the same image data is input to the first to third subpixels SP1, SP2, and SP3 included in the first pixel PXL1 and the first to third color pixels CP1, CP2, and CP3 included in the second pixel PXL2, different values may be output. The second pixel PXL2 may output a gray level corrected by the monopixels TUA1, TUA2, and TUA3 included in the second pixel group UA2. Accordingly, the first to third subpixels SP1, SP2, and SP3 included in the first pixel PXL1 and the first to third subpixels CP1, CP2, and CP3 included in the second pixel PXL2 may output different gray levels for the same image data.

However, the present specification is not limited thereto, and input/output values may be the same according to the gray level input to the second pixel PXL2 and monopixels TUA1, TUA2, and TUA3. For example, when a gray level of 0 is input to the monopixels TUA1, TUA2, and TUA3, the input/output values of the second pixel PXL2 may be the same.

When a gray level of 0 is input to the first to third monopixels TUA1, TUA2, and TUA3 and light of the same intensity is generated in the first and second light source modules 200 and 300 (see FIG. 1), the second pixel group UA2 may have a luminance that is ¼ that of the first pixel group UA1. Accordingly, in the display device according to an example embodiment of the present specification, the second light source module 300 may have a relatively larger luminance value than the first light source module 200 to make the luminance of the first and second display regions DA1 and DA2 uniform.

A difference in luminance between the first and second light source modules 200 and 300 may be a multiple of the total number of second pixels and monopixels included in the second pixel group UA2 divided by the number of second pixels. Alternatively, the difference in luminance between the first and second light source modules 200 and 300 may be a multiple of an area occupied by the second pixel PXL2 relative to an area of the second display region DA2. For example, when the second pixel group UA2 includes one second pixel PXL2 and three monopixels TUA1, TUA2, and TUA3, the luminance of the first and second light source modules 200 and 300 may differ by a factor of four.

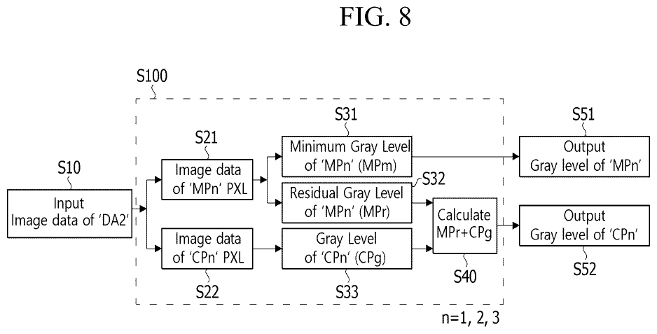

FIG. 7 is a block diagram for describing a process of calculating data of the system unit or a timing controller according to an example embodiment of the present specification. FIG. 8 shows an algorithm for calculating a correction value of the system unit or the timing controller according to an example embodiment of the present specification.

As shown in FIGS. 7 and 8, the system unit or the timing controller according to an example embodiment of the present specification may include an input unit 2000, a calculation unit 3000, and an output unit 4000 that outputs input image data through a compensation algorithm. The compensation algorithm described below is described as implemented in the system unit, but embodiments of the present specification are not limited thereto. For example, the image data may be calculated through the compensation algorithm in the timing controller.

The input unit 2000 may perform a function of inputting image data collected from the outside into the system unit. The input unit 2000 may perform a process of verifying the consistency and completeness of data before transmitting the image data to the calculation unit 3000 of the system unit. The input unit 2000 according to an example embodiment of the present specification may include operation S10 (Input Image data of ‘DA2’) for inputting the image data of the second display region DA2.

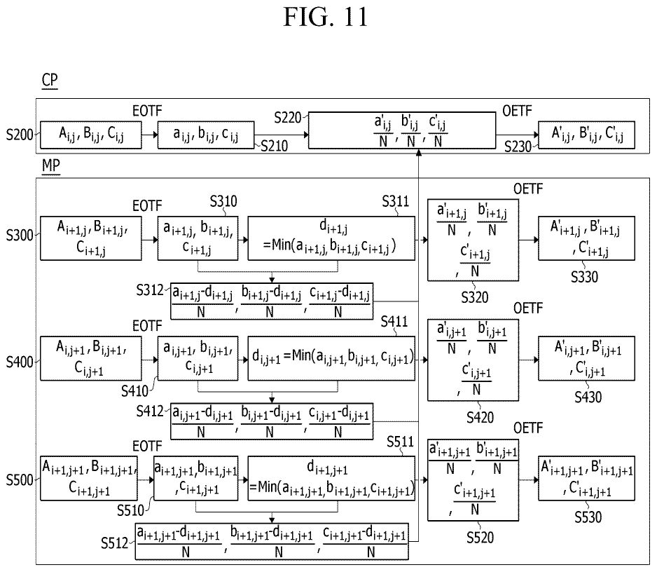

The calculation unit 3000 may perform a function of correcting the image data received from the input unit 2000 according to an algorithm. The calculation unit 3000 may process image data in pixel units or block units, and may apply various correction techniques such as noise removal, color correction, brightness and contrast adjustment, and distortion correction. The calculation unit 3000 according to an example embodiment of the present specification may utilize the compensation algorithm according to FIGS. 8 and 11. The calculation unit 3000 according to an example embodiment of the present specification may include the compensation algorithm according to operation S100.

Operation S100 may include operation S21 (Image data of ‘MPn’ PXL), operation S22 (Image data of ‘CPn’ PXL), operation S31 (Minimum Gray Level of ‘MPn’ (MPm)), operation S32 (Residual Gray Level of ‘MPn’ (MPr)), operation S33 (Gray Level of ‘CPn’ (CPg)), and operation S40 (Calculate MPr+CPg). ‘MPn’ may be the sub-monopixel, and ‘CPn’ may be the color pixel. ‘MPm’ may be the minimum gray level of the sub-monopixels, ‘MPr’ may be the residual gray level of the sub-monopixels, and ‘CPg’ may be the gray level of color pixel.

The image data of the second display region DA2 may have its gray level corrected in units of the second pixel group UA2. Therefore, in operations S21 and S22, the image data of the second pixel group UA2 may be separated into the image data of the first to third monopixels TUA1, TUA2, and TUA3 and the second pixel PXL2.

Operation S21 may separate the image data of each of the first to third monopixels TUA1, TUA2, and TUA3 among the image data of the second pixel group UA2 into the image data of the first to third sub-monopixels MP1, MP2, and MP3.

Operation S22 may separate the image data of the second pixel PXL2 among the image data of the second pixel group UA2 into the image data of the first to third color pixels CP1, CP2, and CP3. n corresponds to a subpixel of each pixel and may be an integer greater than or equal to 1. n may include 1, 2, and 3 with reference to FIG. 5.

Operation S31 may determine the minimum gray level MPm among the image data of the first to third sub-monopixels MP1, MP2, and MP3 separated in operation S21. The determined minimum gray level MPm may be the gray level transmitted to each sub-monopixel.

Setting the gray level of each sub-monopixel to the minimum gray level MPm may be intended to minimize or reduce the degradation of the color reproducibility of the second pixel due to excessive luminance compensation when the monopixel compensates the luminance of the second pixel in the corresponding second pixel group. Therefore, a display device according to an example embodiment of the present specification may minimize or reduce the degradation of the color reproducibility of the second pixel and improve the luminance of the second pixel by selecting the gray level of each sub-monopixel as the minimum gray level MPm.

Operation S32 may calculate the residual gray level MPr by subtracting the minimum gray level MPm from the gray levels of the first to third sub-monopixels MP1, MP2, and MP3. The calculated residual gray level MPr may include a value corresponding to each of the first to third sub-monopixels MP1, MP2, and MP3. Operation S33 may select a gray level CPg of the image data input to the first to third color pixels CP1, CP2, and CP3.

In operation S40, the residual gray levels MPr of the first to third sub-monopixels MP1, MP2, and MP3 may be added to the input gray levels CPg of the corresponding first to third color pixels CP1, CP2, and CP3 so that the gray level transmitted to each color pixel is calculated. For example, in operation S40, in order to calculate the output gray level to the first color pixel CP1, the residual gray level MPr of the first sub-monopixel MP1 and the gray level CPg of the first color pixel CP1 may be added.

The output unit 4000 may receive the corrected image data from the calculation unit 3000 and perform a function of outputting the corrected image data to the outside. The output unit 4000 may output the corrected image data to a display device or store the corrected image data in a storage medium. The output unit 4000 according to an example embodiment of the present specification may include operation S51 (Output Gray level of ‘MPn’) and operation S52 (Output Gray level of ‘CPn’) that output the gray level of each pixel.

In operation S51, the gray level MPm output from each of the first to third sub-monopixels MP1, MP2, and MP3 may be the minimum gray level. The gray levels MPm output from each of the first to third sub-monopixels MP1, MP2, and MP3 may have the same minimum gray level.

In operation S52, the gray level output from each of the first to third color pixels CP1, CP2, and CP3 may be the sum of the input gray level CPg and the residual gray level MPr. A gray level of each of the first to third color pixels CP1, CP2, and CP3 may be output by adding the residual gray level MPr corresponding to the first sub-monopixel MP1 and the input gray level CPg corresponding to the first color pixel CP1, adding the residual gray level MPr corresponding to the second sub-monopixel MP2 and the input gray level CPg corresponding to the second color pixel CP2, and adding the residual gray level MPr corresponding to the third sub-monopixel MP3 and the input gray level CPg corresponding to the third color pixel CP3.

When a plurality of monopixels are provided, the output gray level CPn of the first color pixel CP1 may be a value obtained by adding all residual gray levels MPr corresponding to the first sub-monopixels MP1 of the plurality of monopixels and the input gray level CPg corresponding to the first color pixel CP1. For example, the output gray level CPn of the first color pixel CP1 may be a value obtained by adding residual gray level corresponding to the first sub-monopixel MP1 of the first monopixel TUA1, residual gray level corresponding to the first sub-monopixel MP1 of the second monopixel TUA2, and residual gray level corresponding to the first sub-monopixel MP1 of the third monopixel TUA3 to the input gray level CPg of the first color pixel CP1.

The output gray level CPn of the second color pixel CP2 may be a value obtained by adding all residual gray levels MPr corresponding to the second sub-monopixel MP2 of each of the plurality of monopixels may be added to the input gray level CPg corresponding to the second color pixel CP2. The output gray level CPn of the third color pixel CP3 may be a value obtained by adding all residual gray levels MPr corresponding to the third sub-monopixel MP3 of each of the plurality of monopixels may be added to the input gray level CPg corresponding to the third color pixel CP3.

The input gray level may not be proportional to the actual output brightness. That is, the human eye may not linearly respond to brightness. Therefore, the corrected gray level may be calculated through gamma correction as follows.

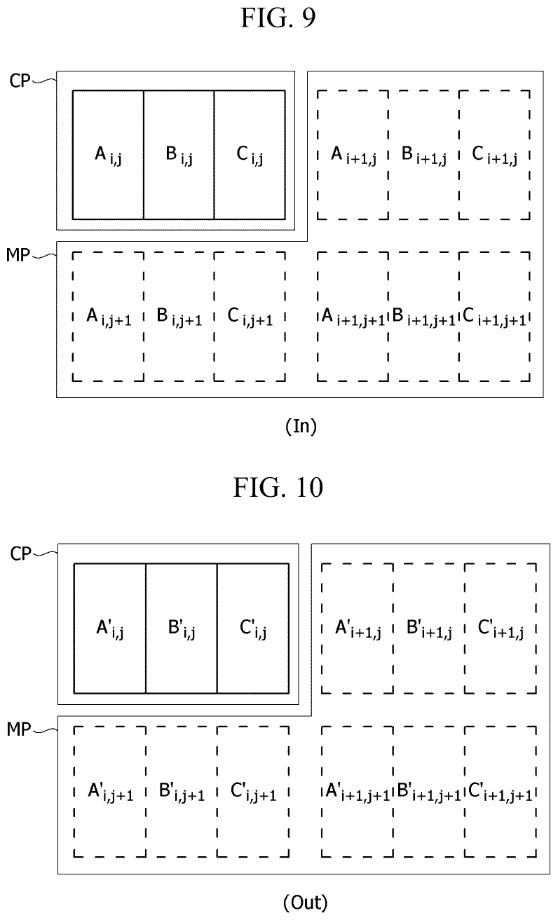

FIG. 9 is a view showing the gray levels input to the second pixel group according to an example embodiment of the present specification. FIG. 10 is a view showing the correction values calculated for the second pixel group according to an example embodiment of the present specification. FIG. 11 shows the algorithm for section S100 in FIG. 8. FIGS. 9 and 10 show the gray levels input and output by the algorithm corresponding to FIG. 11.

As shown in FIGS. 9 to 11, the second pixel group may include one second pixel and three monopixels, and the second pixel and each of the monopixels may include three color pixels CP and three sub-monopixels MP, respectively.

In operation S200, the gray levels (A_{i,j}, B_{i,j}, and C_{i,j}) may be input to the first to third color pixels CP of the second pixel disposed in the first row and first column, respectively. For example, the gray level A_{i,j} may be input to the first color pixel, the gray level B_{i,j} may be input to the second color pixel, and the gray level C_{i,j} may be input to the third color pixel.

In operation S300, the gray levels (A_{i+1,j}, B_{i+1,j}, and C_{i+1,j}) may be input to the first to third sub-monopixels MP of the monopixels disposed in the first row and second column, respectively. In operation S400, the gray levels (A_{i,j+1}, B_{i,j+1}, and C_{i,j+1}) may be input to the first to third sub-monopixels MP of the monopixels disposed in the second row and first column, respectively. In operation S500, the gray levels (A_{i+1,j+1}, B_{i+1,j+1}, and C_{i+1,j+1}) may be input to the first to third sub-monopixels MP of the monopixels disposed in the second row and second column, respectively.

The gray level input to each of the sub-monopixels may be converted into an electro-optical transfer function (EOTF). That is, the algorithm may convert a digital signal (electrical signal) input to the system unit into an analog signal (light signal). An EOTF conversion equation is as shown in the following Equation 1. In Equation 1, V is an input gray level. Vmax is the maximum value of the gray levels and may typically be a value of 255. v is an EOTF conversion value of the input gray level. γ is a gamma value and may typically be a value of 2.2.

v=(V/Vₘₐₓ)^{γ} Equation 1

In operations S210, S310, S410, and S510, the EOTF converted value from the input gray level may be obtained through Equation 1. In operation S210, the values (a_{i,j}, b_{i,j}, and c_{i,j}) may be obtained. In operation S310, the values (a_{i+1,j}, b_{i+1,j}, and c_{i+1,j}) may be obtained. In operation S410, the values (a_{i,j+1}, b_{i,j+}1, and c_{i,j+1}) may be obtained. In operation S510, the values (a_{i+1,j+1}, b_{i+1,j+1}, and c_{i+1,j+1}) may be obtained.

Each of the minimum gray level and residual gray level may be calculated from the EOTF conversion values obtained in operations S310, S410, and S510.

In operations S311, S411, and S511, the minimum gray level may be selected from the EOTF conversion values. In operation S311, the minimum value d_{i+1,j} among the converted values (a_{i+1,j}, b_{i+1,j}, and c_{i+1,j}) may be selected. In operation S411, the minimum value d_{i,j+1} among the converted values (a_{i,j+1}, b_{i,j+1}, and c_{i,j+1}) may be selected. In operation S511, the minimum value d_{i+1,j+1} among the converted values (a_{i+1,j+1}, b_{i+1,j+1}, and c_{i+1,j+1}) may be selected.

In operations S312, S412, and S512, the residual gray level may be calculated by subtracting each of the minimum gray levels from each of the EOTF conversion values and dividing the subtraction result by N. Here, N may satisfy the following Equation 2. N1 is the number of second pixels disposed in the second pixel group, and N2 is the total number of second pixels and monopixels disposed in the second pixel group. For example, in the example embodiment of FIG. 9, N1 may be 1 and N2 may be 4 so that an N value may be 4.

N=N2/N1 Equation 2

Since the display device according to an example embodiment of the present specification has different intensities of the first and second light source modules 200 and 300 (see FIG. 1), the N value according to Equation 2 may be applied. The display device according to an example embodiment of the present specification may supply light with relatively large luminance to the second display region DA2 by considering the transmitting portion formed in the second display region DA2 compared to the first display region DA1.

For example, in display mode, when a plurality of monopixels MP1, MP2, and MP3 have a gray level of 0, a second pixel group UA2 may supply light from a second light source module 300 only to a second pixel PXL2. In this case, since the overall luminance of the second pixel group UA2 needs to be adjusted to the same level as the overall luminance of a first pixel group UA1, the second light source module may supply a luminance of a greater value than the first light source module. Therefore, in the compensation algorithm, the intensity of the second light source module may be taken into account, and each value may be divided by N before conversion into OETF in the calculation process.

In operation S312, the residual gray levels may be (a_{i+1,j}−d_{i+1,j})/N, (b_{i+1,j}−d_{i+1,j})/N, and (c_{i+1,j} di+1,j)/N. In operation S412, the residual gray levels may be (a_{i,j+1}—d_{i,j+1})/N, (b_{i,j+1}−d_{i,j+1})/N, and (c_{i,j+1}−d_{i,j+1})/N. In operation S512, the residual gray levels may be (a_{i+1,j+1}−d_{i+1,j+1})/N, (b_{i+1,j+1}−d_{i+1,j+1})/N, and (c_{i+1,j+1}−d_{i+1,j+1})/N.

The calculated residual gray levels of the monopixels may be added to the EOTF conversion value of the corresponding color pixel. The EOTF conversion value of the color pixel may be divided by N, like the monopixel. In operation S220, Equations 3, 4, and 5 for a′_{i,j}, b′_{i,j}, and c′_{i,j}, respectively, are as follows.

a′_{i,j}={a_{i+1,j}+(a_{i+1,j}−d_{i+1,j})+(a_{i,j+1}−d_{i,j+1})+(a_{i+1,j+1}−d_{i+1,j+1})}/N Equation 3

b′_{i,j}={b_{i+1,j}+(b_{i+1,j}−d_{i+1,j})+(b_{i,j+1}−d_{i,j+1})+(b_{i+1,j+1}−d_{i+1,j+1})}/N Equation 4

c′_{i,j}={c_{i+1,j}+(c_{i+1,j}−d_{i+1,j})+(c_{i,j+1}−d_{i,j+1})+(c_{i+1,j+1}−d_{i+1,j+1})}/N Equation 5

The value calculated in operation S220 may be used to calculate a gray level to be input to each color pixel again through the OETF conversion. That is, the calculated analog signal (light signal) may be converted into a digital signal (electrical signal). The OETF conversion equation is as shown in the following Equation 6.

V=Vₘₐₓ×(v^{1/γ}) Equation 6

In operation S230, as a result of the calculation in Equation 6, the color pixel may have gray levels A′_{i,j}, B′_{i,j}, and C′_{i,j}.

For each of the monopixels, the minimum gray level is selected in operations S320, S420, and S520, and the resulting value is divided by N. In operation S320, a′_{i+1,j}, b′_{i+1,j}, and c′_{i+1,j} may have the same value d_{i+1,j}. In operation S420, a′_{i,j+1}, b′_{i,j+1}, and c′_{i,j+1} may have the same value d_{i,j+1}. In operation S520, a′_{i+1,j+1}, b′_{i+1,j+1}, and c′_{i+1,j+1} may have the same value d_{i+1,j+1}.

The value calculated in operations S320, S420, and S520 may be used to calculate a gray level to be input to each sub-monopixel again through the OETF conversion. The OETF conversion equation may be the above-described Equation 6.

In operation S330, as a result of the calculation in Equation 6, the first sub-monopixels may have gray levels A′_{i+1,j}, B′_{i+1,j}, and C′_{i+1,j}. In operation S430, as a result of the calculation in Equation 6, the second sub-monopixels may have gray levels A′_{i,j+1}, B′_{i,j+1}, and C′_{i,j+1}. In operation S530, as a result of the calculation in Equation 6, the third sub-monopixels may have gray levels A′_{i+1,j+1}, B′_{i+1,j+1}, and C′_{i+1,j+1}.

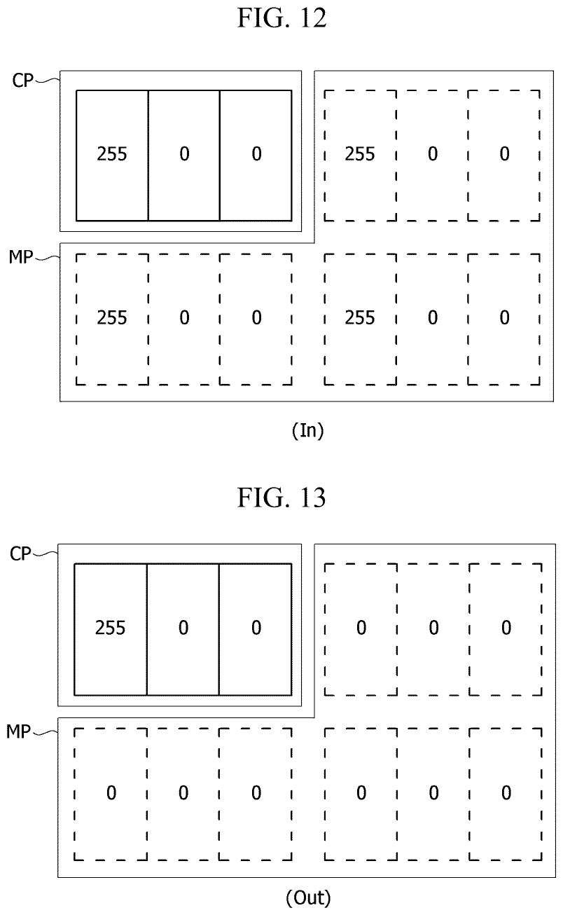

FIG. 12 is a view showing an example of gray levels input to the second pixel group. FIG. 13 is a view showing the correction values calculated for the second pixel group of FIG. 12. The values of FIGS. 12 and 13 may be calculated by the compensation algorithm of FIG. 11.

As shown in FIG. 12, when the gray level has steps ranging from 0 to 255, gray levels (255, 0, and 0) may be input to a color pixel CP, and gray levels (255, 0, and 0) may be input to each monopixel MP. That is, chromatic image data may be input to the color pixel CP and the monopixel MP. For example, gray levels (255, 0, and 0) may be image data of any one of red, blue, and green. The color pixel CP may be compensated for an input value by a minimum value difference from the input value of the monopixel MP by the above-described compensation algorithm, and each monopixel MP may have a minimum gray level.

As shown in FIG. 13, the gray levels output from the system unit by the above-described compensation algorithm may be (255, 0, and 0) for the color pixel CP and (0, 0, and 0) for monopixels MP. That is, the color pixel CP may emit the maximum amount of light of the corresponding color. When at least one of the sub-monopixels of a monopixel MP receives a value of 0, output values may be (0, 0, and 0).

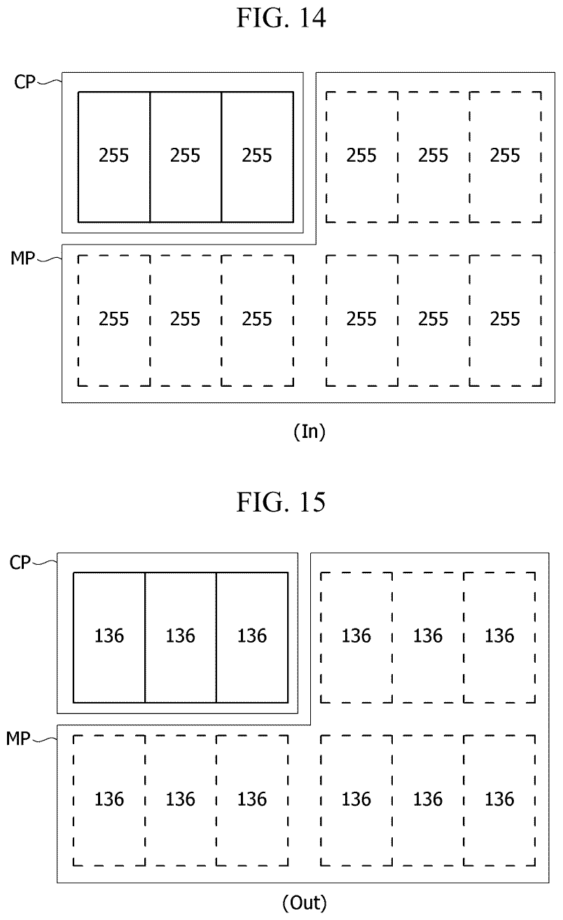

FIG. 14 is a view showing another example of gray levels input to the second pixel group. FIG. 15 is a view showing the correction values calculated for the second pixel group of FIG. 14. The values of FIGS. 14 and 15 may be calculated by the compensation algorithm of FIG. 11.

As shown in FIG. 14, when the gray level has steps ranging from 0 to 255, gray levels (255, 255, and 255) may be input to a color pixel CP, and gray levels (255, 255, and 255) may be input to monopixels MP. That is, white image data may be input to the color pixel CP and the monopixel MP as an achromatic color. The color pixel CP may be compensated for an input value by a minimum value difference from the input value of the monopixel MP by the above-described compensation algorithm, and each monopixel MP may have a minimum gray level.

As shown in FIG. 15, the gray levels output from the system unit by the above-described compensation algorithm may be (136, 136, and 136) for the color pixel CP and (136, 136, and 136) for monopixels MP. That is, when white image data is input to the color pixel CP, the second pixel group may emit light not only from the color pixel CP, but also from the monopixels MP disposed around the color pixel CP. Therefore, the display device according to an example embodiment of the present specification may have improved image expressiveness for the color pixels compared to a state in which the monopixels MP are not used (black state).

According to FIGS. 12 to 15, it can be confirmed that the display device according to an example embodiment of the present specification has a relatively greater effect when achromatic image data is input to the color pixel CP than when chromatic image data is input. The monopixel is a region that has only luminance without color but may be recognized by the human eye as dark or bright white. Therefore, since the monopixel provides a color compensation effect for achromatic color pixels, the display device according to an example embodiment of the present specification may more effectively improve the image expressiveness of achromatic images.

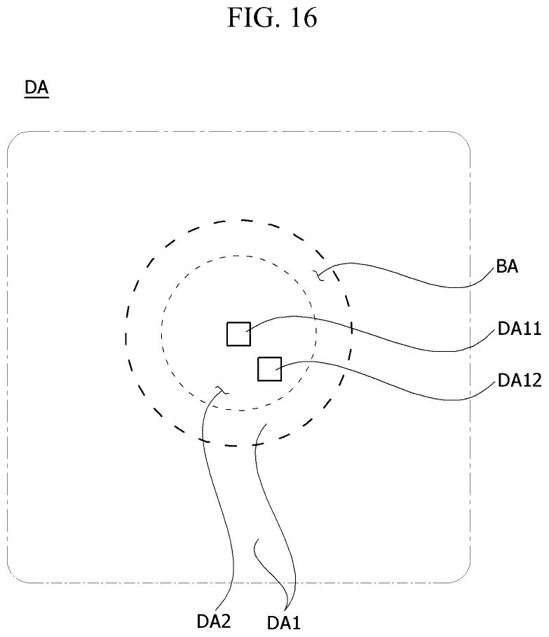

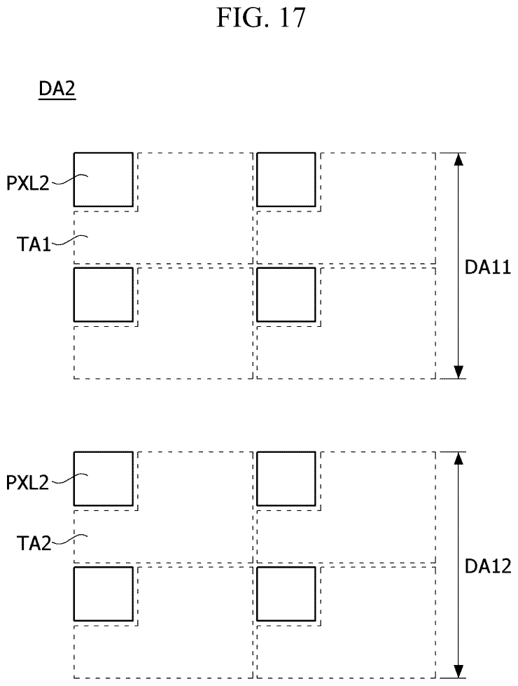

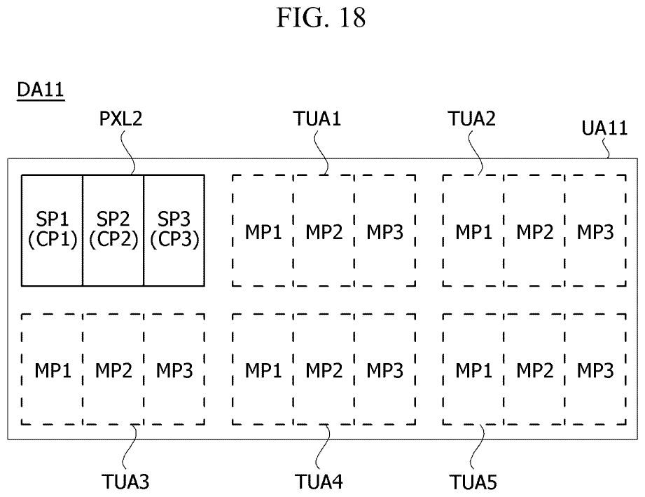

FIG. 16 is a view showing a first display region and a second display region according to another example embodiment of the present specification. FIG. 17 is a view showing an eleventh display region and a twelfth display region according to another example embodiment of the present specification. FIG. 18 is a view showing an eleventh pixel group according to another example embodiment of the present specification.

As shown in FIGS. 16 to 18, the display device according to another example embodiment of the present specification may include an eleventh display region DA11 and a twelfth display region DA12, which are different, in a second display region DA2, and include a boundary region BA around the second display region DA2.

According to another example embodiment, the number of second pixels PXL2 may gradually decrease from a portion in which the second display region DA2 meets the boundary region BA toward a center region thereof. The twelfth display region DA12 may be disposed closer to the boundary region BA than the eleventh display region DA11. The eleventh display region DA11 and the twelfth display region DA12 may include unit areas at different points in the second display region DA2. The number of second pixels PXL2 included in the eleventh display region DA11 may be less than the number of second pixels PXL2 included in the twelfth display region DA12. The eleventh display region DA11 and the twelfth display region DA12 may include different pixel groups.

The eleventh display region DA11 may be a region in which second pixels PXL2 and first transmitting portions TA1 are repeatedly disposed. The twelfth display region DA12 may be a region in which second pixels PXL2 and second transmitting portions TA2 are repeatedly disposed. The first transmitting portion TA1 may have a substantially larger area than the second transmitting portion TA2. The first and second transmitting portions TA1 and TA2 may each include a plurality of monopixels. The number of monopixels disposed in the first transmitting portion TA1 may be greater than the number of monopixels disposed in the second transmitting portion TA2.

The second pixel group UA2 of FIG. 5 may be repeatedly disposed in the twelfth display region DA12.

An eleventh pixel group UA11, which includes one second pixel PXL2 and five monopixels, such as first to fifth monopixels TUA1, TUA2, TUA3, TUA4, and TUA5, may be repeatedly disposed in the eleventh display region DA11.

In this case, different N values may be applied to the eleventh and twelfth display regions DA11 and DA12 in the compensation algorithm according to FIG. 11. According to Equation 2 described above, N may be set to 6 in the eleventh display region DA11 and N may be set to 4 in the twelfth display region DA12 so that gray levels are calculated by the compensation algorithm.

The display device according to another example embodiment of the present specification is not limited thereto, and when a plurality of display regions having different pixel groups are present in the second display region DA2, different N values may be applied to each of the display regions.

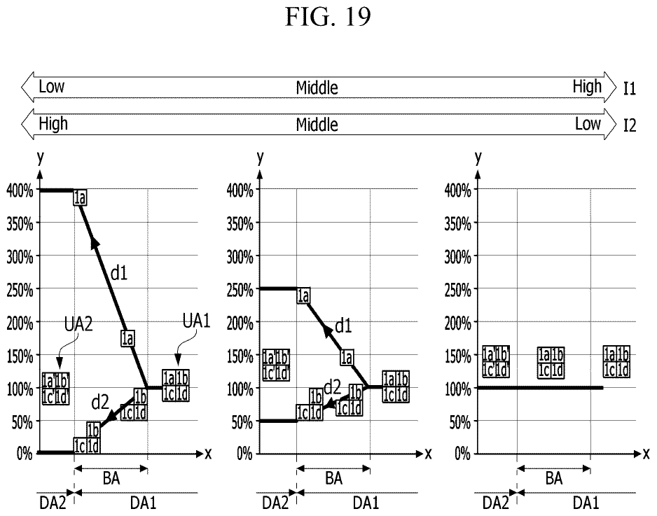

FIG. 19 is a view for describing a method of compensating the luminance of a boundary region BA according to another example embodiment of the present specification. In FIG. 19, the x-axis represents the positions of first and second display regions DA1 and DA2, and the y-axis represents the relative luminance value (%).

As shown in FIG. 19, the boundary region BA may be included in the first display region DA1. The boundary region BA may be disposed around the second display region DA2. For example, the boundary region BA may be disposed along the perimeter of the second display region DA2.

The first display region DA1 may have the same pixel arrangement as the boundary region BA and a region excluding the boundary region BA. However, the boundary region BA may be smoothed to prevent or suppress a recognized difference in luminance that may occur due to a difference in density of pixels (first pixel, second pixel, color pixel) in which the color filter of the first display region DA1 and the second display region DA2 is disposed.

The smoothing process may gradually change the luminance of first pixels PXL1 disposed in the boundary region BA as the first pixels PXL1 become closer to the second display region DA2. That is, the smoothing process may change the gray level in units of the first pixel group UA1 as the first pixels PXL1 disposed in the boundary region BA become closer to the second display region DA2.

According to FIG. 19, the display device according to another example embodiment of the present specification may be configured such that the second light source module, which supplies light to the second display region DA2 in the previous example embodiment, also supplies light to the boundary region BA so that the luminance of the boundary region BA can be controlled for the smoothing process. For example, the second light source module of the present specification according to FIG. 19 may overlap both the second display region DA2 and the boundary region BA. Accordingly, the display device of the present specification according to FIG. 19 may adjust the luminance of the boundary region BA to a level equal to that of the second display region DA2.

As shown in FIG. 19, the first display region DA1 may include a 1-1 pixel 1a, a 1-2 pixel 1b, a 1-3 pixel 1c, and a 1-4 pixel 1d in each first pixel group UA1. The second display region DA2 may include a second pixel 1a′ and first to third monopixels 1b′, 1c′, and 1d′ in each second pixel group UA2. The area and the number of pixels of the first pixel group UA1may be determined based on the area and the number of pixels corresponding to the second pixel group UA2.

A compensation intensity I2 of the boundary region BA may vary according to a gray level I1 of the first to third monopixels 1b′, 1c′, and 1d′ of the second pixel group UA2. Here, the second pixel group UA2 to be compared with the boundary region BA may be disposed adjacent to the boundary region BA in the second display region DA2.

The compensation intensity I2 of the boundary region BA may be inversely proportional to the gray level I1 of the first to third monopixels 1b′, 1c′, and 1d′ of the second pixel group UA2. For example, as the gray level I1 of the first to third monopixels 1b′, 1c′, and 1d′ of the second pixel group UA2 increases (in a High direction of I1), the compensation intensity I2 of the boundary region BA may decrease (in a Low direction of I2).

The boundary region BA may maintain the same value as the gray levels of the first to third monopixels 1b′, 1c′, and 1d′ when the gray level I1 of the first to third monopixels 1b′, 1c′, and 1d′ of the second pixel group UA2 is at its maximum (High of I1). That is, when the gray level I1 of the first to third monopixels 1b′, 1c′, and 1d′ is at its maximum (High of I1), compensation may not be made to make the gray level of the boundary region BA different for each region. In this case, since the second display region DA2 has enhanced image expressiveness, the boundary line at the point in which the second display region DA2 meets the boundary region BA may be barely perceptible.

As the gray level I1 of the first to third monopixels 1b′, 1c′, and 1d′ decreases, the gray level of the boundary region BA may be gradually changed as the boundary region BA approaches the second display region DA2. In this case, the boundary region BA may gradually increase (in a d1 direction) the gray level of the 1-1 pixel 1a corresponding to the second pixel 1a′ of the second pixel group UA2 as the boundary region BA approaches the second display region DA2. In contrast, the boundary region BA may gradually decrease (in a d2 direction) the gray levels of the 1-2 to 1-4 pixels 1b, 1c, and 1d corresponding to the first to third monopixels 1b′, 1c′, and 1d′ of the second pixel group UA2 as the boundary region BA approaches the second display region DA2.

For example, when the gray level I1 of the first to third monopixels 1b′, 1c′, and 1d′ is at a middle level (Middle), in the first pixel group UA1 of the boundary region BA, the 1-1 pixel 1a may emit a luminance of up to about 250% as the 1-1 pixel 1 a becomes closer to the second display region DA2, and the 1-2 to 1-4 pixels 1b, 1c, and 1d may emit a luminance of at least about 50% as the 1-2 to 1-4 pixels 1b, 1c, and 1d become closer to the second display region DA2.

For example, when the gray level I1 of the first to third monopixels 1b′, 1c′, and 1d′ is at a 0 level (Low), in the first pixel group UA1 of the boundary region BA, the 1-1 pixel 1a may emit a luminance of up to about 400% as the 1-1 pixel 1a becomes closer to the second display region DA2, and the 1-2 to 1-4 pixels 1b, 1c, and 1d may emit a luminance of at least about 0% as the 1-2 to 1-4 pixels 1b, 1c, and 1d become closer to the second display region DA2.

As described above, in example embodiments of the present specification, the image expressiveness by the compensation algorithm may be improved as the color approaches achromatic colors. In comparison, since the image with chromatic colors has relatively low expressiveness, the boundary line between the first display region DA1 and the second display region DA2 may be recognized. Accordingly, the display device according to example embodiments of the present specification may prevent or suppress a boundary line from being recognized due to a difference in luminance between the first display region DA1 and the second display region DA2 through smoothing processing.

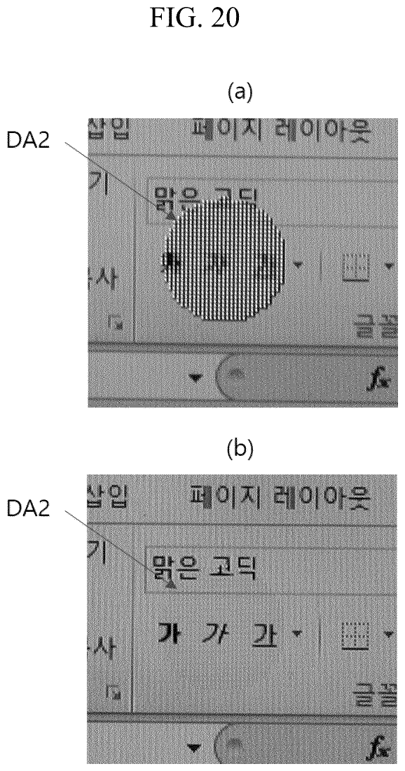

FIG. 20 shows an image showing the screen (see part (a) of FIG. 20) before and the screen (see part (b) of FIG. 20) after the compensation algorithm according to an example embodiment of the present specification is applied.

As shown in FIG. 20, before the compensation algorithm is applied (see part (a) of FIG. 20), it can be seen that the image of the second display region DA2 has slightly lower expressiveness than the other display region. Additionally, it can be seen that the second display region DA2 has a distinct edge where the second display region DA2 meets the other display region.

After the compensation algorithm is applied (see part (b) of FIG. 20), it can be seen that the image of the second display region DA2 has improved image expressivity to be almost similar to that of the other display region. In the case after the compensation algorithm is applied (see part (b) of FIG. 20), the compensation of the boundary region is not performed, and only the compensation algorithm of the second display region DA2 is applied, but it can be seen that the boundary between the second display region DA2 and other display region is hardly distinguishable.

A display device according to an example embodiment of the present specification may include a display panel including a first display region including a plurality of first pixels, and a second display region including a plurality of second pixels and a plurality of monopixels, and a sensor that receives light through the second display region, wherein the second display region operates in a sensing mode in which light is incident on the sensor when the sensor operates and in a display mode in which an image is displayed, and in the display mode, the plurality of monopixels have different gray levels.

In the display device according to an example embodiment of the present specification, each of the plurality of monopixels may include a plurality of sub-monopixels, and in display mode, each of the plurality of sub-monopixels may have the same gray level.

In the display device according to an example embodiment of the present specification, the display device may include a system unit for transmitting a control signal to pixels, and each of the plurality of monopixels may include a plurality of sub-monopixels, and in display mode, the plurality of sub-monopixels may receive, as an input, one or more different gray levels and output a minimum value among the one or more different gray levels.

In the display device according to an example embodiment of the present specification, the second display region may include a first pixel group including at least one second pixel and at least one monopixel, and in display mode, the first pixel group may compensate at least one second pixel for a difference value between a gray level input and a gray level output to and from at least one monopixel.

In the display device according to an example embodiment of the present specification, each of the plurality of second pixels may include a plurality of color pixels, each of the plurality of color pixels may correspond to one of the plurality of sub-monopixels, and in display mode, the first pixel group may compensate for a difference value between a plurality of sub-monopixels for a plurality of corresponding color pixels.

In the display device according to an example embodiment of the present specification, the first display region may further include a boundary region disposed around the second display region, and gray levels of the plurality of first pixels disposed in the boundary region may gradually change as the plurality of first pixels become closer to the second display region.

In the display device according to an example embodiment of the present specification, the second display region may include a first pixel group including at least one second pixel and at least one monopixel, the boundary region may include a second pixel group including a plurality of first pixels corresponding to the first pixel group, a gray level of a first pixel of the second pixel group corresponding to at least one second pixel may gradually increase as the first pixel approaches the second display region, and the gray level of the first pixel of the second pixel group corresponding to at least one monopixel may gradually decrease as the first pixel approaches the second display region.

In the display device according to an example embodiment of the present specification, when gray levels of the plurality of monopixels in the second display region disposed adjacent to the boundary region are maximum values, the plurality of first pixels disposed in the boundary region may have the same gray levels as the plurality of monopixels.

In the display device according to an example embodiment of the present specification, the second display region may further include a 2-1 display region and a 2-2 display region that is disposed closer to the first display region than the 2-1 display region, the 2-1 display region may include a 1-1 pixel group including at least one second pixel and at least one monopixel, the 2-2 display region may include a 1-2 pixel group including at least one second pixel and at least one monopixel, and the total numbers of second pixels and monopixels in the 1-1 pixel group and the 1-2 pixel group may be different.

In the display device according to an example embodiment of the present specification, the display device may further include a first light source module that supplies light to the first display region, and a second light source module that supplies light to the second display region, and the luminance of the second light source module may be greater than that of the first light source module.

In the display device according to an example embodiment of the present specification, the display device may further include a color filter, and the color filter may be disposed in the plurality of first and second pixels and may not be disposed in the monopixel.

A display device according to an example embodiment of the present specification may include a first display region including a first pixel and a monopixel, and a system unit configured to transmit a control signal to the first pixel and the monopixel, wherein the system unit may be further configured to calculate a first correction value of a first gray level from image data corresponding to the first pixel, calculate a second correction value of a second gray level from image data corresponding to the monopixel, and compensate the first gray level for a difference value between the second gray level and the second correction value during a calculation of the first correction value.

A display device according to example embodiments of the present specification can implement a full screen display with improved expressiveness of an imaging region in display mode.

Additionally, a display device according to example embodiments of the present specification can minimize or reduce the recognized difference in luminance between different display regions.

The effects of the present specification are not limited to the effects described above, and other effects that are not described can be clearly understood from the description herein by a person having ordinary skill in the technical field to which the technical idea of the present specification belongs.

Therefore, the example embodiments disclosed in the present specification are not intended to limit the technical spirit of the present disclosure, but intended to describe the same by way of example, and the scope of the technical spirit of the present disclosure is not limited by these embodiments.

Accordingly, the example embodiments disclosed in the present disclosure are not intended to limit the technical spirit of the present disclosure but illustrate it, and the scope of the technical spirit of the present disclosure is not limited by these example embodiments.

Accordingly, the above-described example embodiments should be understood as examples in all aspects and not restrictive.

Accordingly, the above-described example embodiments should be understood in all respects as illustrative and not restrictive.

What is claimed is:

1. A display device, comprising:
a display panel that includes a first display region including a plurality of first pixels and a second display region including a plurality of second pixels and a plurality of monopixels; and
a sensor configured to receive light through the second display region,
wherein the second display region operates in a sensing mode in which light is incident on the sensor when the sensor operates and in a display mode in which an image is displayed, and
wherein, in the display mode, the plurality of monopixels have different gray levels.

2. The display device of claim 1, wherein:
each of the plurality of monopixels includes a plurality of sub-monopixels; and
in the display mode, each of the plurality of sub-monopixels has the same gray level.

3. The display device of claim 1, further comprising a system unit configured to transmit a control signal to pixels,
wherein each of the plurality of monopixels includes a plurality of sub-monopixels, and
wherein, in the display mode, the system unit is further configured to input one or more different gray levels to the plurality of sub-monopixels and to output a minimum value among the one or more different gray levels.

4. The display device of claim 3, wherein:
the second display region includes a first pixel group including one or more of the second pixels and one or more of the monopixels; and
in the display mode, the first pixel group compensates the one or more of the second pixels for a difference value between a gray level input to the one or more of the monopixels and the minimum gray level.

5. The display device of claim 4, wherein:
each of the plurality of second pixels includes a plurality of color pixels;
each of the plurality of color pixels corresponds to one of the plurality of sub-monopixels; and
in the display mode, the first pixel group compensates the plurality of corresponding color pixels for a difference value between the plurality of sub-monopixels.

6. The display device of claim 1, wherein:
the first display region further includes a boundary region disposed around the second display region; and
gray levels of the plurality of first pixels disposed in the boundary region gradually change as the plurality of first pixels become closer to the second display region.

7. The display device of claim 6, wherein:
the second display region includes a first pixel group including one or more of the second pixels and one or more of the monopixels;
the boundary region includes a second pixel group including a plurality of first pixels corresponding to the first pixel group;
in the second pixel group, a gray level of a first pixel corresponding to the one or more of the second pixels gradually increases as the first pixel approaches the second display region; and
in the second pixel group, a gray level of a first pixel corresponding to the one or more of the monopixels gradually decreases as the first pixel approaches the second display region.

8. The display device of claim 6, wherein, in the display mode, when a gray level of the monopixel disposed adjacent to the boundary region is a maximum value, gray levels of the plurality of first pixels disposed in the boundary region are the same as gray levels of the plurality of monopixels.

9. The display device of claim 1, wherein:
the second display region further includes a 2-1 display region and a 2-2 display region disposed closer to the first display region than the 2-1 display region;
the 2-1 display region includes a 1-1 pixel group including one or more of the second pixels and one or more of the monopixels;
the 2-2 display region includes a 1-2 pixel group including one or more of the second pixels and one or more of the monopixels; and
total numbers of second pixels and monopixels in the 1-1 pixel group and the 1-2 pixel group are different.

10. The display device of claim 1, further comprising:
a first light source module configured to supply light to the first display region; and
a second light source module configured to supply light to the second display region,
wherein a luminance of the second light source module is greater than a luminance of the first light source module.

11. The display device of claim 1, further comprising a color filter,
wherein the color filter is disposed on the plurality of first and second pixels and is not disposed on the plurality of monopixels.

12. A display device, comprising:
a first display region including a plurality of first pixels and a plurality of monopixels; and
a system unit configured to transmit a control signal to the first pixels and the monopixels,
wherein the system unit is further configured to:
calculate a first correction value for a first gray level from image data corresponding to each of the first pixels;
calculate a second correction value for a second gray level from image data corresponding to each of the monopixels; and
compensate the first gray level for a difference value between the second gray level and the second correction value during a calculation of the first correction value.

13. The display device of claim 12, further comprising a sensor configured to receive light through the first display region,
wherein the first display region includes the plurality of monopixels and operates in a sensing mode in which light is incident on the sensor when the sensor operates and in a display mode in which an image is displayed, and
wherein, in the display mode, the second correction values of the plurality of monopixels are different.

14. The display device of claim 12, wherein:
each of the plurality of monopixels includes a plurality of sub-monopixels; and
in a display mode, the plurality of sub-monopixels have the same or different second gray levels and have the same second correction value.

15. The display device of claim 14, wherein the second correction value of the plurality of sub-monopixels is a minimum value among the same or different second gray levels.

16. The display device of claim 12, wherein:
the first display region includes a first pixel group including one or more of the first pixels and the plurality of monopixels; and
the system unit is further configured to compensate the first gray level for a difference value between the second gray level and the second correction value of each of the plurality of monopixels during the calculation of the first correction value.

17. The display device of claim 16, wherein:
the one or more of the first pixels includes a plurality of color pixels each having a first gray level;
the monopixel includes a plurality of sub-monopixels each having a second gray level and corresponding to the plurality of color pixels; and
the system unit is further configured to compensate for a difference value between the second gray level of the sub-monopixel corresponding to the first gray level and the second correction value during the calculation of the first correction value of the one or more of the first pixels.
